(19) United States
(12) Patent Application Publication
(10) Pub. No.: US 2015/0145795 A1
(43) Pub. Date: May 28, 2015

(54) METHOD FOR CONTROLLING TOUCH PANEL

(71) Applicant: TIANJIM FUNAYUANCHUANG TECHNOLOGY CO., LTD., Tianjin (CN)

(72) Inventors: CHIEN-YUNG CHENG, New Taipei (TW); PO-SHENG SHIH, New Taipei (TW); LI-MIN CHAO, New Taipei (TW)

(21) Appl. No.: 14/552,898

(22) Filed: Nov. 25, 2014

(30) Foreign Application Priority Data
Nov. 28, 2013 (CN) 201310615546.3

(51) Int. Cl. G06F 3/041

(52) U.S. Cl. CPC G06F 3/041
USPC 345/173

(57) ABSTRACT

A method for controlling a touch panel is disclosed. A first driving signal is applied to the driving electrodes to obtain a number of first electrical signals on a first area of the touch panel. The first electrical signals are converted into a number of first digital signals by digital analog conversion with a first factor. A second driving signal is applied to a number of driving electrodes to obtain a number of second electrical signals on a second area of the touch panel. The second electrical signals are converted into a number of second digital signals by digital analog conversion with a second factor. The second factor is greater than the first factor.

### RELATED APPLICATIONS

This application claims all benefits accruing under 36 U.S.C. §119 from China Patent Application No. 201310615546.3, filed on Nov. 28, 2013 in the China Intellectual Property Office, the disclosure of which is incorporated herein by reference. This application is related to applications entitled, “METHOD FOR CONTROLLING TOUCH PANEL,” filed ______ (Atty. Docket No. US50230).

### FIELD

The present disclosure relates to a method for controlling a touch panel, especially a method for controlling a touch panel with large size.

### BACKGROUND

Touch sensing technology is capable of providing a natural interface between an electronic system and a user, and has found widespread applications in various fields, such as mobile phones, personal digital assistants, automatic teller machines, game machines, medical devices, liquid crystal display devices, and computing devices.

There are different types of touch panels, such as a capacitive touch panel. The capacitive touch panels generally comprise a driving layer and a sensing layer opposite to the driving layer. The driving layer comprises a first conductive layer and a plurality of driving electrodes located on a side of the first conductive layer along a first direction. The first conductive layer comprises a plurality of first conductive paths spaced from each other and oriented along a second direction perpendicular to the first direction. The sensing layer comprises a second conductive layer and a plurality of sensing electrodes located on a side of the second conductive layer along the second direction. The second conductive layer comprises a plurality of second conductive paths spaced from each other and oriented along the first direction.

In controlling the capacitive touch panel, a same driving signal is applied to the plurality of driving electrodes one by one, at the same time a plurality of electrical signals are obtained by the plurality of sensing electrodes; and then the plurality of electrical signals is converted into a plurality of digital signals by digital analog conversion with a same amplified factor to obtain the coordinates of touch spots on the touch panel. However, because of the resistance of the first conductive layer, the driving signal would be attenuated along the second direction. Thus, the plurality of electrical signals obtained by the sensing electrodes would decrease along the second direction, which greatly effect the touch-controlling precision of capacitive touch panel, especially for a large size touch panel.

What is needed, therefore, is to provide a method for controlling the touch panel, which can overcome the above-described shortcomings.

### BRIEF DESCRIPTION OF THE DRAWINGS

Implementations of the present technology will now be described, by way of example only, with reference to the attached figures.

FIG. 1 shows a schematic structural view of one embodiment of a driving layer of a touch panel.

FIG. 2 shows a schematic structural view of one embodiment of a sensing layer of a touch panel.

FIG. 3 shows a schematic structural view of one embodiment of a touch panel.

FIG. 4 shows a flow chart of one embodiment of a method for controlling the touch panel shown in FIG. 3.

FIG. 5 shows a chart of voltage changes of coupling capacitance during the controlling process of the touch panel shown in FIG. 4.

FIG. 6 shows a flow chart of another embodiment of a method for controlling the touch panel shown in FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The term “substantially” is defined to be essentially conforming to the particular dimension, shape, or other feature that the term modifies, such that the component need not be exact. The term “comprising” means “including, but not necessarily limited to”; it specifically indicates open-ended inclusion or membership in a so-described combination, group, series, and the like.

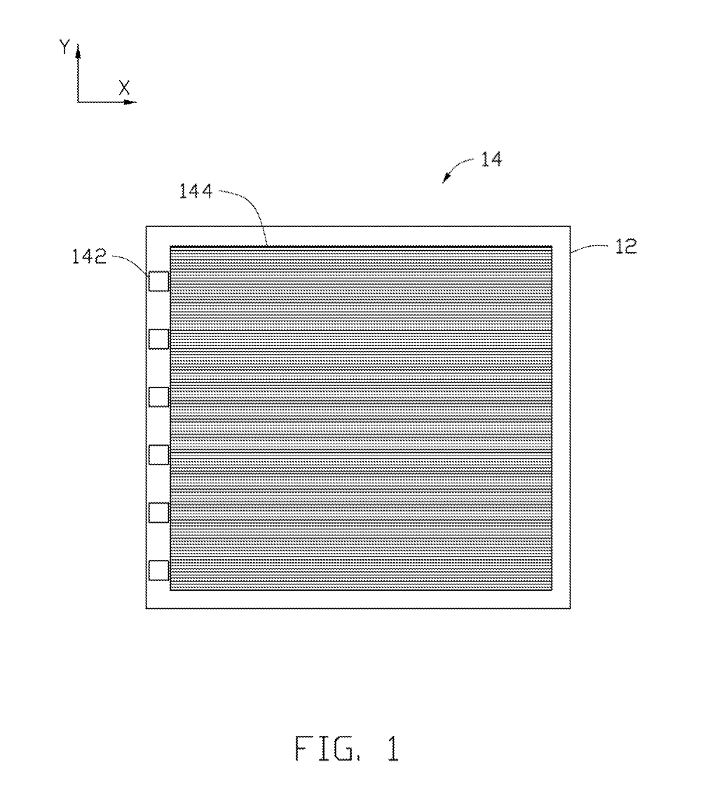

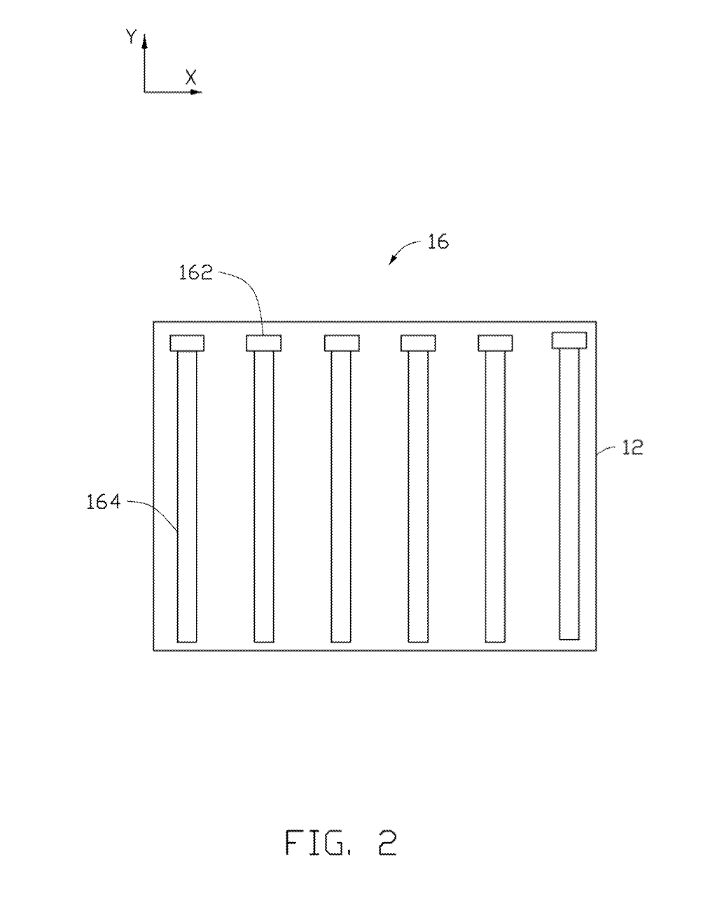

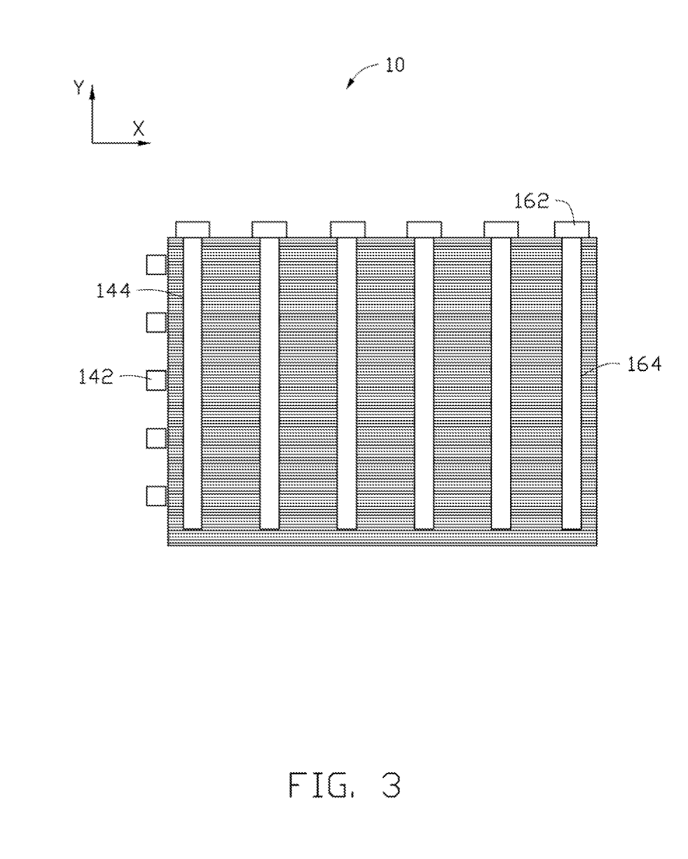

FIGS. 1-3 illustrate that a touch panel 10 of one embodiment is provided. The touch panel 10 comprises a substrate 12, a driving layer 14, a sensing layer 16 and a controlling Integrated circuit (IC) electrically connected to the driving layer 14 and the sensing layer 16. The substrate 12 comprises a first surface and a second surface opposite to the first surface. The driving layer 14 is located on the first surface. The sensing layer 16 is located on the second surface.

The driving layer 14 comprises a plurality of driving electrodes 142 and a conductive layer 144. The plurality of driving electrodes 142 are located on a side of the conductive layer 144 along a direction Y, and are electrically connected to the controlling IC. Thus, the conductive layer 144 can be electrically connected to the controlling IC by the plurality of driving electrodes 142. The conductive layer 144 consists of at least one layer of carbon nanotube film drawn directly from a carbon nanotube array. The carbon nanotube film consists of a plurality of carbon nanotubes joined end to end by van der Waals force and oriented along a direction X substantially perpendicular to the direction Y. Thus, a plurality of conductive paths along the direction X can be formed. In some embodiments, the direction X is cross with the direction Y. The carbon nanotube film is a free-standing structure. That is, the term ‘free-standing’ includes films that do not have to be supported by a substrate.

The carbon nanotube film has minimum impedance along the X direction and maximum impedance along the Y direction so as to have anisotropic impedance. In one embodiment, the conductive layer 144 consists of one layer of carbon nanotube film. The conductive layer 144 can also consist of a plurality of indium tin oxide (ITO) stripes or metal stripes spaced from each other and oriented along the direction X.

The sensing layer 16 comprises a plurality of sensing electrodes 162 and a plurality of parallel conductive stripes 164. The plurality of conductive stripes 164 are oriented along the direction Y and spaced from each other. Each of the plurality of sensing electrodes 162 is located on a side of each of the plurality of conductive stripes 164 respectively, and is electrically connected to the controlling IC. Thus, the plurality of conductive stripes 164 can be electrically connected to the controlling IC by the plurality of sensing electrodes 162. A material of the plurality of conductive stripes 164 can be ITO or metal. In one embodiment, the plurality of conductive stripes 164 are a plurality of parallel ITO stripes oriented along the direction Y.

The sensing layer 16 can be divided into a first area and a second area along a boundary parallel to the direction Y. In one embodiment, the boundary is a medial axis of the sensing layer 16 parallel to the direction Y. The sensing electrodes 162 on the first area can be defined as first sensing electrodes. The sensing electrodes 162 on the second area can be defined as second sensing electrodes.

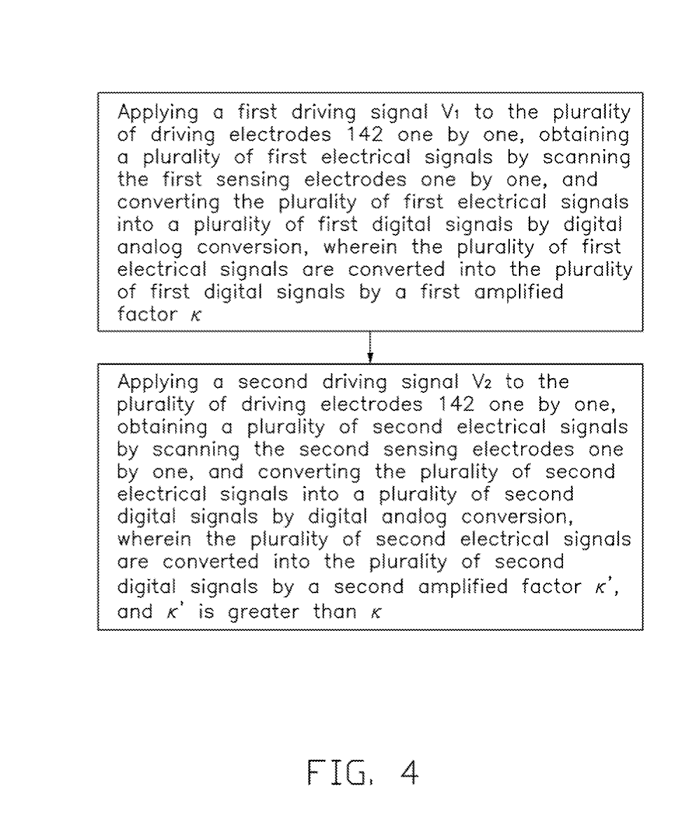

FIG. 4 illustrates that a method for controlling the touch panel 10 of one embodiment, comprises the steps of:

S10: applying a first driving signal V₁ to the plurality of driving electrodes 142 one by one, obtaining a plurality of first electrical signals by scanning the first sensing electrodes one by one, and converting the plurality of first electrical signals into a plurality of first digital signals by digital analog conversion, wherein the plurality of first electrical signals are converted into the plurality of first digital signals by a first amplified factor κ; and

S11: applying a second driving signal V₂ to the plurality of driving electrodes 142 one by one, obtaining a plurality of second electrical signals by scanning the second sensing electrodes one by one, and converting the plurality of second electrical signals into a plurality of second digital signals by digital analog conversion, wherein the plurality of second electrical signals are converted into the plurality of second digital signals by a second amplified factor κ′, and κ′ is greater than κ.

In step S10, when the first driving signal V₁ is applied to one of the plurality of driving electrodes 142, the other driving electrodes 142 without the applied first driving signal V₁ can be connected to ground or floating. When one of the first sensing electrodes is scanned to obtain one of the first electrical signals, the other first sensing electrodes and all of the second sensing electrodes can be connected to ground or floating. In one embodiment, when the first driving signal V₁ is applied to one of the plurality of driving electrodes 142, the other driving electrodes 142 without the applied first driving signal V₁ are connected to ground; and when one of the first sensing electrodes is scanned to obtain one of the first electrical signals, the other first sensing electrodes and all of the second sensing electrodes are connected to ground.

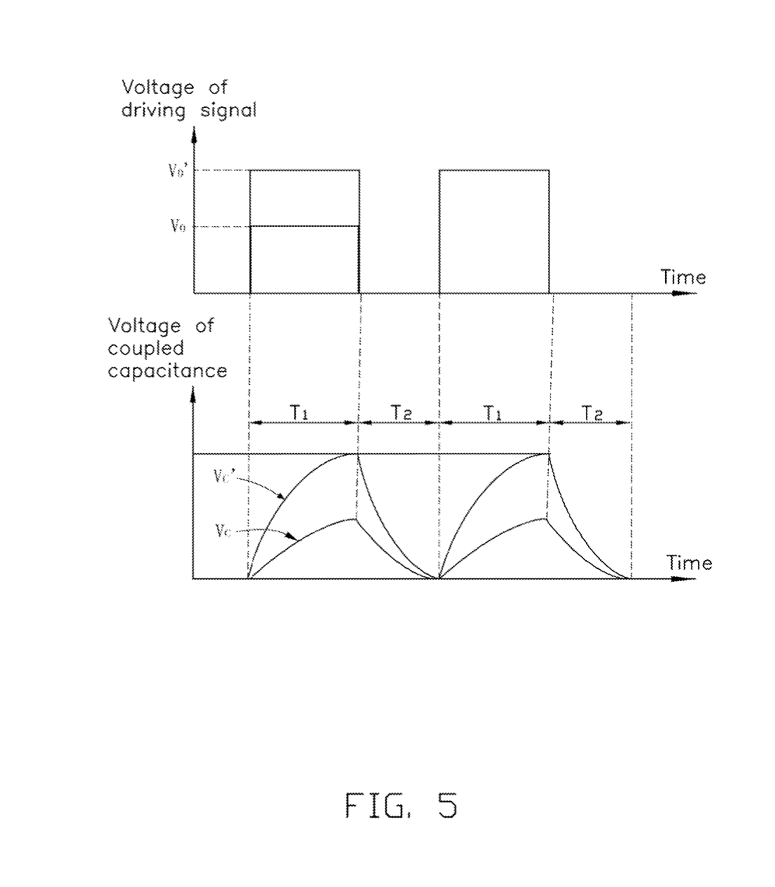

The plurality of first electrical signals are converted into the plurality of first digital signals by the controlling IC. It is to be noted that, the greater the first amplified factor κ is, the greater numbers first electrical signals can be obtained. FIG. 5 illustrates that V_{C} curve represents voltage change of a coupled capacitance between the driving layer 14 and the plurality of conductive stripes 164 on the first area. During a period T₁, the first driving signal V₁ is applied to the plurality of conductive stripes 164 by the controlling IC to charge the coupled capacitance between the driving layer 14 and the plurality of conductive stripes 164. At the same time, the first sensing electrodes are scanned by the controlling IC to obtain the plurality of first electrical signals. The values of the plurality of first electrical signals are depended upon the values of first driving signal V₁. That is, the greater the first driving signal V ₁ applied, the greater the plurality of first electrical signals can be obtained. In one embodiment, the values of the first driving signal V₁ is V₀. During a period T₂, the coupled capacitance between the driving layer 14 and the plurality of conductive stripes 164 discharges. It is to be noted that, when touch movements are applied on the first area of the touch panel 10, coordinates of the touch movements can be obtained by the plurality of first digital signals.

In step S11, when the second driving signal V₂ is applied to one of the plurality of driving electrodes 142, the other driving electrodes 142 without the applied first driving signal V₂ can be connected to ground or floating. When one of the second sensing electrodes is scanned to obtain one of the second electrical signals, the other second sensing electrodes and all of the first sensing electrodes can be connected to ground or floating. In one embodiment, when the second driving signal V₂ is applied to one of the plurality of driving electrodes 142, the other driving electrodes 142 without the applied second driving signal V₂ are connected to ground; and when one of the second sensing electrodes is scanned to obtain one of the plurality of second electrical signals, the other second sensing electrodes and all of the first sensing electrodes are connected to ground.

The plurality of second electrical signals are converted into a plurality of second digital signals by the controlling IC. It is to be noted that, the greater the second amplified factor κ′ is, the greater the second electrical signals obtained. Because the second amplified factor κ′ is greater than the first amplified factor κ, the values of the second electrical signals can be substantially equal to the values of the first electrical signals. Thus, a touch-controlling precision of touch panel can be improved. In some embodiments, the second amplified factor κ′ and the first amplified factor κ satisfy: 3κ≧κ′>κ. In one embodiment, the second amplified factor κ′ and the first amplified factor κ satisfy: κ′=2κ.

FIG. 5 illustrates that the V_{C}′ curve represents voltage change of a coupled capacitance between the driving layer 14 and the plurality of conductive stripes 164 on the second area. During the period T₁, the second driving signal V₂ is applied to the plurality of conductive stripes 164 by the controlling IC to charge the coupled capacitance between the driving layer 14 and the plurality of conductive stripes 164. At the same time, the second sensing electrodes are scanned by the controlling IC to obtain the plurality of second electrical signals. The values of the plurality of second electrical signals are depended upon the values of second driving signal V₂. That is, the greater the values of the second driving signal V₂ are, the greater values of the second electrical signals can be obtained. The values of the second driving signal V₂ can be greater than or equal to the values of the first driving signal V₁. When values of the second driving signal V₂ is greater than the values of the first driving signal V₁, the coupled capacitance between the driving layer 14 and the plurality of conductive stripes 164 can be fully charged. Thus, the values of the plurality of second electrical signals and the plurality of first digital signals can be increased. In one embodiment, the second driving signal V₂ is V₀′. During the period T₂, the coupled capacitance between the driving layer 14 and the plurality of conductive stripes 164 discharges. In the embodiment, when touch movements are applied on the second area of the touch panel 10, coordinates of the touch movements can be obtained by the plurality of second digital signals.

The sensing layer 16 can be divided into at least two areas according to the size of the touch panel 10 along at least one boundary parallel to the direction Y. Furthermore, the method for controlling the touch panel 10 is suitable to use on the touch panel 10 with a size of greater than or equal to 10 inches.

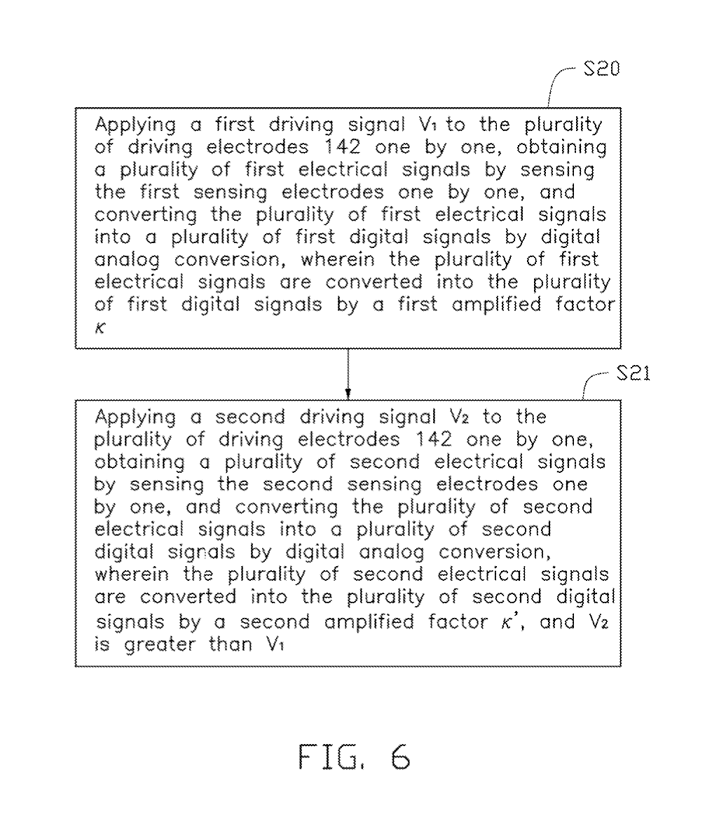

FIG. 6 illustrates that a method for controlling the touch panel 10 of another embodiment, comprises the steps of:

S20: applying a first driving signal V₁ to the plurality of driving electrodes 142 one by one, obtaining a plurality of first electrical signals by sensing the first sensing electrodes one by one, and converting the plurality of first electrical signals into a plurality of first digital signals by digital analog conversion, wherein the plurality of first electrical signals are converted into the plurality of first digital signals by a first amplified factor κ; and

S21: applying a second driving signal V₂ to the plurality of driving electrodes 142 one by one, obtaining a plurality of second electrical signals by sensing the second sensing electrodes one by one, and converting the plurality of second electrical signals into a plurality of second digital signals by digital analog conversion, wherein the plurality of second electrical signals are converted into the plurality of second digital signals by a second amplified factor κ′, and V₂ is greater than V₁.

The steps of S20 and S21 are substantially the same as the steps of S10 and S11, except that the value of the second amplified factor κ′ is equal to the value of the first amplified factor κ. That is, the plurality of second electrical signals is just amplified by the increment of the second driving signal V₂. In some embodiments, the first driving signal V₁ and the second driving signal V₂ satisfies: 3V₁≧V₂>V₁. In one embodiment, the first driving signal V₁ and the second driving signal V₂ satisfies: 2V₁=V₂.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A method for controlling a touch panel comprising:
providing the touch panel comprising a driving layer and a sensing layer opposite to the driving layer; the driving layer comprising a first conductive layer and a plurality of driving electrodes located on a side of the first conductive layer along a first direction; the sensing layer comprising a second conductive layer and a plurality of sensing electrodes located on a side of the second conductive layer along a second direction cross with the first direction; wherein the sensing layer is divided into a first area and a second area along a boundary parallel to the second direction, the plurality of sensing electrodes located on the first area are defined as first sensing electrodes, the plurality of sensing electrodes located on the second area are defined as second sensing electrodes;
applying a first driving signal V₁ to the plurality of driving electrodes one by one, obtaining a plurality of first electrical signals by scanning the first sensing electrodes one by one, and converting the plurality of first electrical signals into a plurality of first digital signals by digital analog conversion with a first amplified factor κ; and
applying a second driving signal V₂ to the plurality of driving electrodes one by one, obtaining a plurality of second electrical signals by scanning the second sensing electrodes one by one, and converting the plurality of second electrical signals into a plurality of second digital signals by digital analog conversion with a second amplified factor κ′;
wherein the second amplified factor κ′ is greater than the first amplified factor κ.

2. The method as claimed in claim 1, wherein a relationship between the second amplified factor κ′ and the first amplified factor κ is: 3κ≧κ′>κ.

3. The method as claimed in claim 2, wherein the relationship between the second amplified factor κ′ and the first amplified factor κ is: 2κ=κ′.

4. The method as claimed in claim 1, wherein when the first driving signal V₁ is applied to one of the plurality of driving electrodes, the un-droved driving electrodes are connected to ground or floating.

5. The method as claimed in claim 1, wherein when one of the first sensing electrodes is scanned to obtain one of the plurality of first electrical signals, the un-scanned first sensing electrodes and all of the second sensing electrodes are connected to ground or floating.

6. The method as claimed in claim 1, wherein when the second driving signal V₂ is applied to one of the plurality of driving electrodes, the un-droved driving electrodes are connected to ground or floating.

7. The method as claimed in claim 1, wherein when one of the second sensing electrodes is scanned to obtain one of the plurality of second electrical signals, the un-scanned second sensing electrodes and all of the first sensing electrodes are connected to ground or floating.

8. The method as claimed in claim 1, wherein the boundary is a medial axis of the sensing layer parallel to the second direction.

9. A method for controlling a touch panel comprising:
providing the touch panel comprising a driving layer and a sensing layer opposite to the driving layer; the driving layer comprising a first conductive layer and a plurality of driving electrodes located on a side of the first conductive layer along a first direction; the sensing layer comprising a second conductive layer and a plurality of sensing electrodes located on a side of the second conductive layer along a second direction cross with the first direction; wherein the sensing layer is divided into a first area and a second area along a boundary parallel to the first direction, the plurality of sensing electrodes located on the first area are defined as first sensing electrodes, the plurality of sensing electrodes located on the second area are defined as second sensing electrodes;
applying a first driving signal V₁ to the plurality of driving electrodes one by one, obtaining a plurality of first electrical signals by scanning the first sensing electrodes one by one, and converting the plurality of first electrical signals into a plurality of first digital signals by digital analog conversion with a first amplified factor κ; and
applying a second driving signal V₂ to the plurality of driving electrodes one by one, obtaining a plurality of second electrical signals by scanning the second sensing electrodes one by one, and converting the plurality of second electrical signals into a plurality of second digital signals by digital analog conversion with a second amplified factor κ′;
wherein the second driving signal V₂ is greater than the first driving signal V₁.

10. The method as claimed in claim 9, wherein a relationship between the second amplified factor κ′ and the first amplified factor κ is: 3 V₁≧V₂>V₁.

11. The method as claimed in claim 10, wherein the relationship between the second amplified factor κ′ and the first amplified factor κ is: 2V₁=V₂.

12. A method for controlling a touch panel comprising:
providing the touch panel comprising a driving layer and a sensing layer opposite to the driving layer; the driving layer comprising a first conductive layer and a plurality of driving electrodes located on a side of the first conductive layer along a first direction; the sensing layer comprising a second conductive layer and a plurality of sensing electrodes located on a side of the second conductive layer along a second direction cross with the first direction; wherein the sensing layer is divided into a first area and a second area along a boundary parallel to the first direction, the plurality of sensing electrodes located on the first area are defined as first sensing electrodes, the plurality of sensing electrodes located on the second area are defined as second sensing electrodes;
applying a first driving signal V₁ to the plurality of driving electrodes one by one, obtaining a plurality of first electrical signals by scanning the first sensing electrodes one by one, and converting the plurality of first electrical signals into a plurality of first digital signals by digital analog conversion with a first amplified factor κ; and
applying a second driving signal V₂ to the plurality of driving electrodes one by one, obtaining a plurality of second electrical signals by scanning the second sensing electrodes one by one, and converting the plurality of second electrical signals into a plurality of second digital signals by digital analog conversion with a second amplified factor κ′;
wherein the second amplified factor κ′ is greater than the first amplified factor κ, and the second driving signal V₂ is greater than the first driving signal V₁.

13. The method as claimed in claim 12, wherein a relationship between the second amplified factor κ′ and the first amplified factor κ is: 3 V₁≧V₂>V₁.

14. The method as claimed in claim 13, wherein the relationship between the second amplified factor κ′ and the first amplified factor κ is: 3κ≧κ′>κ.

15. The method as claimed in claim 12, wherein a size of the touch panel is greater than or equal to 10 inches.

16. The method as claimed in claim 12, wherein when the first driving signal V₁ is applied to one of the plurality of driving electrodes, the un-droved driving electrodes are connected to ground or floating.

17. The method as claimed in claim 12, wherein when one of the first sensing electrodes is scanned to obtain one of the plurality of first electrical signals, the un-scanned first sensing electrodes and all of the second sensing electrodes are connected to ground or floating.

18. The method as claimed in claim 12, wherein when the second driving signal V₂ is applied to one of the plurality of driving electrodes, the un-droved driving electrodes are connected to ground or floating.

19. The method as claimed in claim 12, wherein when one of the second sensing electrodes is scanned to obtain one of the plurality of second electrical signals, the un-scanned second sensing electrodes and all of the first sensing electrodes are connected to ground or floating.

20. The method as claimed in claim 12, wherein the first direction is perpendicular to the second direction.
